(19) United States
(12) Patent Application Publication
(10) Pub. No.: US 2024/0370835 A1
(43) Pub. Date: Nov. 7, 2024

(54) Method and system for enabling credit card owners to allocate money to recipients to make cardless payments by credit card terminals

(71) Applicant: Meir Dahan, Tveria (IL)

(72) Inventor: Meir Dahan, Tveria (IL)

(21) Appl. No.: 18/142,042

(22) Filed: May 2, 2023

(51) Int. Cl. G06Q 20/02; G06Q 20/40

(52) U.S. Cl. CPC G06Q 20/027; G06Q 20/4014

(57) ABSTRACT

A method and system for enabling a credit card owner to allocate a certain amount of money to a recipient to use the money to make cardless payments using a credit card terminal, that includes the receiving by servers the allocation request from a computing device of the owner by means of a computer application, the cardless payments require input in to the terminal of a specific mobile phone number that the owner specified in the request, receiving by the terminal the input of the mobile number, generating a one-time password to be input in to the terminal, and transmitting this password to that mobile number, receiving by the terminal the input of that password, verifying that the password that was input in to the terminal matches the generated password, and authorizing the payment.

### TECHNICAL FIELD

The present invention refers to a method and system for authorizing a credit card charge by a third party identified by a mobile phone number.

### BACKGROUND ART

The present invention provides a good solution to many needs and problems, and mainly to the following: First, in many cases an owner of a credit card wants to give money using his credit card to another person (recipient) who does not have a settlement (clearing) agreement with a credit card corporation, and giving money using a credit card is not possible to private people but only to businesses, and sometime it is even impossible to pay by credit card to a small business, such as a babysitter, manicure master, etc. Second, very often a credit card owner needs to give sum of money to a member of family that needs to make shopping and the only way is to give cash (assuming that it is not allowed to give the credit cards itself). Third, many people prefer to receive money without digital tracing. This does not mean that it is an illegal receipt of money or a desire to avoid reporting to the tax authorities, rather, this need sometimes stems from an approach that advocates personal freedom not to be tracked and also from a desire to avoid the need to give legitimate explanations for receiving funds legally that there was no legal need to report them, which involves in expense and trouble, and to avoid the need to give such explanations there are interests in receiving sums of money without leaving digital traces of the receipt of the money. The present invention provides a good solution to these problems, as well as other problems of transferring sums of money to friends, family members and others by making it possible to allocate money from a credit card directly to the benefit and use of that people.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a flow chart of the method 200.

FIG. 2 is a block diagram that depicts the system (200S) with the servers (32), the processing devices (31), the credit card terminal (201), the computing device (33), the mobile phone (35) and the computer application (34).

### THE INVENTION

The main objective of the present invention is to provide a computer-implemented method for enabling an owner of a credit card to allocate a certain amount of money to a third party recipient, such that the third party recipient is authorized to use the allocated certain amount of money to make one or more cardless payments using a credit card terminal (201). The third party recipient is able and authorized to make the one or more cardless payments using the credit card terminal by input a specific mobile phone number that the owner sets in the request for allocation the certain amount of money. The credit card terminal can be physical or virtual and the purchase can be in front of the recipient (such in a café or a restaurant) or remote purchase (such as shopping online by internet or over the phone).

The term “credit card” in this disclosure and in the claims means any kind of credit card, debit card, gift card, prepaid card, and in general any plastic card and also any kind of a virtual card that become popular recently (and the word ‘card’ still used in their names though there is no card in fact) that are downloaded for example on mobile phones, smartphones, and any kind of means that used for payments.

The method is performed by processing devices (31) running on one or more servers (32) and one or more credit card terminals (201) that are programed to be functioned and to be used for executing the method.

The method includes the following steps and means:

A. Step reference number (200A): this step is optionally, but in any case the owner should use the relevant computer application (which is likely to run under the consent of the credit card company): Receiving, by the one or more servers (32) from a computing device (33) of the credit card owner, a request to login to a computer application (34) (in which the credit card owner may have a profile). The term “login” in this disclosure and in the claims means also to “logon” and therefore the request to login to the computer application may include the need to provide one or more security feature submitted by the owner of the credit card such as a password, a PIN, or a biometric as it is customary in this filed. The term “the computing device (33) of the owner” means the device that he uses for entering the computer application.

The term “computing device” (33) in this disclosure and in the claims means any kind of computer that includes an internet access, such as a smartphone, a mobile phone, a tablet, laptop, desktop and the like. The term “computer application” (34) literally means computer software applications that enable users and owners of credit cards (or bank accounts for example) to operate their account.

B. Step reference number (200B): this step is optionally, but in any case the owner should inset some identification to ensure that it is he that make the request): Granting, by the one or more servers, authorization to said computing device of the owner to access to the computer application. The access to the computer application may be in response to verifying that the submitted security feature match the profile security feature stored in the user profile in the server that run the computer application, as customary done when a person wishes to login to his account by a computer.

C. Step reference number (200C): Receiving, by the one or more servers, a request from the computing device of the credit card owner, by means of said computer application, to allocate the certain amount of money to the third party recipient so that he become authorized and able to make the one or more cardless payments limited to the certain amount of money from the credit card of the owner through credit card terminals upon entering said specific mobile phone number at the relevant credit card terminal. Means that the one or more cardless payments requires an input in to the credit card terminal of the specific mobile phone number that the credit card owner specified as part of the request to allocate the amount of money to the third party recipient.

The computer application enables to set the amount of money that the owner wants to enable that third person to use from his credit card account and the specific mobile phone number of that recipient (no need to give or get specific passwords in this stage for executing these payments). The owner needs to add nothing beyond that. The owner should enter to the computer application the phone number of the recipient and the limited amount (and maybe to tap “Done” or “Send”) and by that he sends the request. The computer application may be designed in a way that it will enable the owner to determine whether the allocation of said money is reversible or irreversible. “Reversible” means that that the request to enable the one or more payments limited to the certain amount of money can be canceled as to the part of the certain amount of money that yet was not used at the moment of cancelation of the request, and determining by the one or more servers that said request is reversible; “Irreversible” means that that the request to enable the one or more payments limited to the certain amount of money cannot be canceled at all, and determining by the one or more servers that said request is irreversible. So, when recipient receives the message that the certain amount is irreversible he can see it as a certain amount that fully paid to him and not on a condition. It is understood that the owner should enter a specific mobile phone number that is possessed by the third party recipient that he wishes to enable him to process these authorized credit card payments (or with access to that specific mobile phone number), and the owner knows that the method includes the step (the need) of the recipient to enter OTP phone verification that will be sent as SMS for example to the mobile phone (35) of the recipient using that phone number. When recipient wishes to get money without tracing he can buy a sim without providing identification, which is legal at many democratic countries as part of the personal freedom.

The computer application may be designed in a way that it will enable the owner to determine whether the allocation of said money can be canceled (reversible allocation) or whether from the moment he approves the allocation then it cannot be returned (irreversible allocation). Also, it is possible and desirable that, immediately after the allocation is made, the system that operates this method will send a message to the mobile phone number of the recipient informing him that the owner has allocated to him that certain amount of money and that the allocation can be canceled (revisable), or cannot be canceled (irreversible), and it is possible that the message (SMS) will include a period of time in which he must use the money otherwise the allocation will be canceled automatically (this for cases in which the recipient lost his sim with that mobile phone number for example).

D. Step reference number (200D): Receiving, by the credit card terminal, (an entry) the input of the specific mobile phone number that is required in order for processing a specific cardless payment. In this step, when the recipient wishes to purchase products or services (restaurants, shops, online shops, and the like) there is a need to enter his specific mobile phone number into the credit card terminal of that provider/seller/shop.

The existing credit card terminals are fit for this mission if updating their program operation, such as, by adding an option to press a button or to tap on their touch screens to select option to pay by phone number for example, or a selection on the computing device when shopping or paying online. In the case of a smart terminal, such as those found for example in hotels on a desktop computer, then the terminal can include a direct button for selecting payment as mentioned, and the same when paying online, and if it is a small physical terminal without a touch screen, such as those used in restaurants, then it is possible to re-program them in a way that when pressing continuously (for example) on a certain existing key then the option for entering the phone number will be opened. The person that enters the phone number and the OTP is the recipients when shopping online for example, or the seller (in shops and café).

E. Step reference number (200E): In response to the input of the specific mobile phone number in to the credit card terminal, the one or more servers generate and transmit to the specific mobile phone number (to the mobile device in which the sim of this number is activated) an SMS or another type of message with the onetime password OTP (similar to phone verification). The fact that the OTP that enables the payments is generated and transmitted a moment before each payment and directly to the recipient is an important part and it is an effective protection mechanism.

F. Step reference number (200F): Receiving, by the credit card terminal, the input of the onetime password (OTP), means that the recipient or the seller or another person needs to enter at the credit card terminal (physically or virtually) the OTP for completing the payment.

G. Step reference number (200G): Verifying, by the one or more servers or by the credit card terminal, that the onetime password (OTP) that was input in to the credit card terminal matches the generated onetime password (OTP). The match can be done for example in the credit card terminal itself (means that the one or more servers send the OTP also the credit card terminal) or on the one or more servers. The verification can be done by comparing the entered OPT with the generated OTP, in the one or more servers, the credit card terminal, or in a database located in the one or more servers.

Before verifying the OTP or before authorizing the specific payment, it is desirable that the one or more servers will determine whether the specific payment (together with other payment done before) do not exceed the limited certain amount of money.

H. Step reference number (200H): authorizing, by the one or more servers or by the credit card terminal, the specific payment upon said verification. In general, card authorization is approval from a credit or debit card issuer (usually a bank or credit union) that states the cardholder has sufficient funds or the available credit needed to cover the cost of a transaction they're using a card to complete.

The credit card company can charge the owner's credit card for the certain amount he allocated to that third party at any time and in several ways, for example: in the case of an irrevocable (irreversible) allocation, the credit card company can charge the credit card of the owner at the moment of allocation for the entire allocation amount, or lock the allocation amount so that it will no longer be available for use by the cardholder. It is possible to charge the card after each specific payment operation at the specific payment amount. The manner and time of the charge can be made in several dates and ways.

In other words, the request to allocate the certain amount of money can be reversible, and in this case the servers or the computer applications enabling the credit card owner to cancel the allocation. Another option of the method, the request to allocate the certain amount of money cab be irreversible, and in such case the servers or the computer applications limiting the credit card owner to cancel the allocation (means, that in the regular automatic options the owner is disabled from having the option to cancel such irreversible allocation, but he may have the option to do so throng a specific request that will be decided by a representative of the credit card company in a certain special cases). In response to irreversible request, the method may send a message to the specific mobile phone number stating that the allocation of the certain amount of money is irreversible.

The method can be designed to enable the recipient to use for payments through credit card terminals part of the money, and he can use the balance at another time. Also, the method can be designed to enable to include the possibility that in case that several amounts have been assigned (allocated) to the same phone number by several people (credit card owners), then the details of the senders can be displayed on the credit card terminal's display and the recipient will be given the option to choose from whom to pay the relevant payment. It is possible and desirable that after each purchase, both the credit card owner and the recipient will receive a message from the servers informing them that a transaction has been approved for x amount and that the remaining balance for use is y for example.

Another objective of the present invention is to provide a computer system (200S) for enabling the owner of the credit card to allocate funds and by that to enable one or more payments limited in total to the certain amount of money from his credit card using credit card terminals (201) by the third party recipient with access to a specific mobile phone number. In general the parts of the system (200S) are same to the parts and steps of the method (200) and there is no need to repeat theme.

The communications means and methods between the computing devices, the servers, the credit card terminals, the computer application, are known to experts in the field and therefore there is no need to describe them in this disclosure,

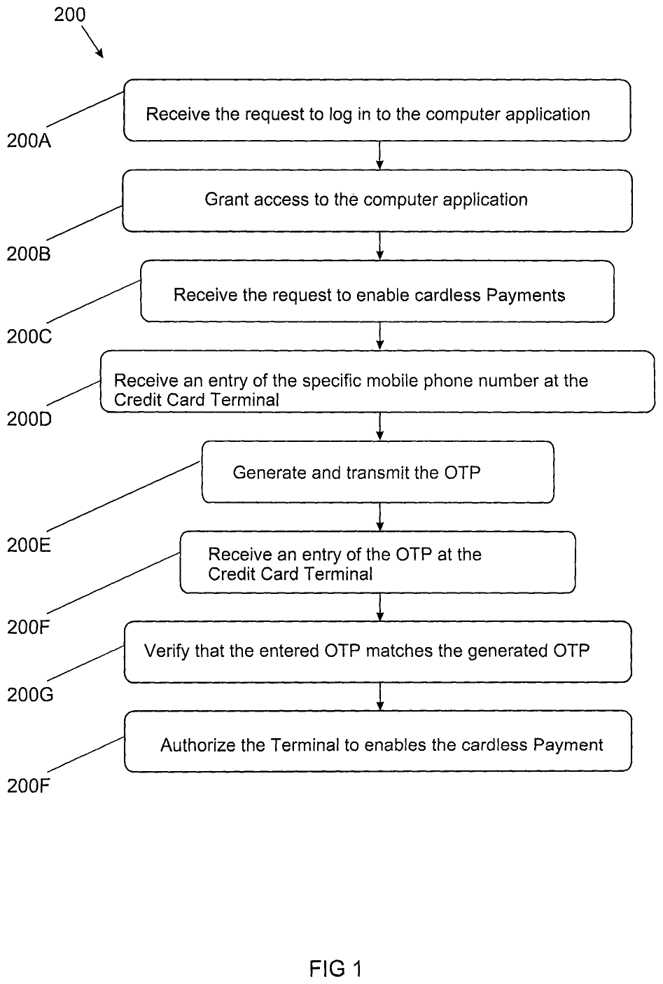

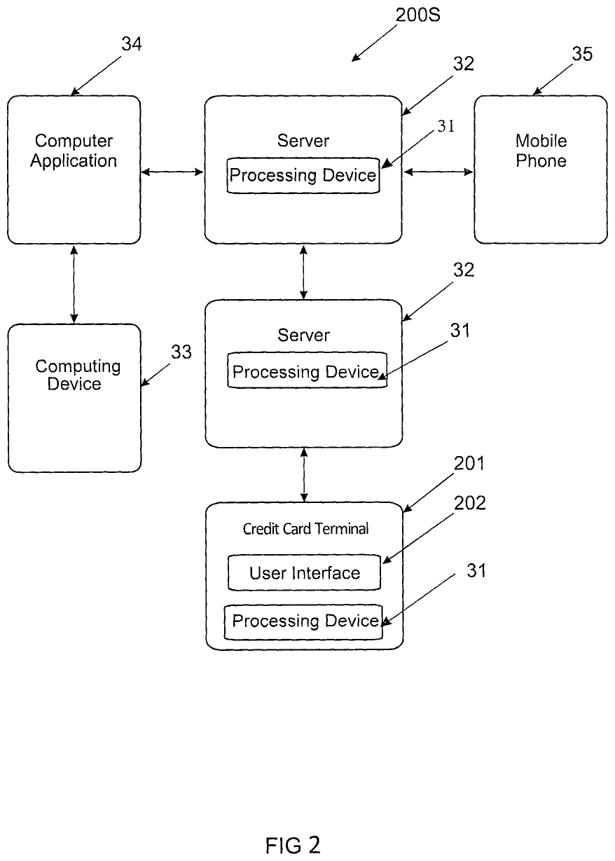

FIG. 1 is a flow chart of the method 200. FIG. 2 is a block diagram that schematically depicts the system (200S) with the servers (32), the processing devices (31), the credit card terminal (201) with its user interface (202) for entering the specific mobile phone number and the OTP, the computing device (33) of the owner, the mobile phone (35) of the recipient and the computer application (34).

What is claimed is:

1. A computer-implemented method for enabling an owner of a credit card to allocate a certain amount of money to a third party recipient to enable the third party recipient to use the allocated certain amount of money to make one or more cardless payments using a credit card terminal, the method comprises the following steps:
receiving, by the one or more servers, a request from a computing device of the credit card owner, by means of a computer application, to allocate said amount of money to the third party recipient to enable the third party recipient to make the one or more cardless payments through the credit card terminal, wherein said one or more cardless payments requires input in to the credit card terminal of a specific mobile phone number that the credit card owner specified as part of the request to allocate said amount of money to said third party recipient;
receiving, by the credit card terminal, the input of said mobile phone number that is required in order to process a specific cardless payment;
generating, by the one or more servers, in response to said input of said mobile phone number in to the credit card terminal, a one-time password (OTP) to be input in to the credit card terminal, and transmitting said one-time password (OTP) to said mobile phone number;
receiving, by the credit card terminal, the input of the one-time password (OTP);
verifying, by the one or more servers or by the credit card terminal, that the one-time password (OTP) that was input in to said credit card terminal matches the generated one-time password (OTP); and
authorizing, by the one or more servers or by the credit card terminal, the specific cardless payment upon said verification.

2. The computer-implemented method of claim 1, wherein said request to allocate said amount of money is reversible, and wherein the method further comprises: enabling, by said one or more servers or said computer application, said credit card owner to cancel said allocation.

3. The computer-implemented method of claim 1, wherein said request to allocate said amount of money is irreversible, and wherein the method further comprises: limiting, by said one or more servers or said computer application, said credit card owner to cancel said allocation.

4. The computer-implemented method of claim 3 that further comprises: generating, by the one or more servers, in response to said irreversible request to allocate said amount of money, a message stating that said allocation of said amount of money is irreversible, and transmitting the message to said mobile phone number.

5. A computer system for enabling an owner of a credit card to allocate a certain amount of money to a third party recipient to enable the third party recipient to use the allocated certain amount of money to make one or more cardless payments using a credit card terminal, the computer system configured to:
receive, by the one or more servers, a request from a computing device of the credit card owner, by means of a computer application, to allocate said amount of money to the third party recipient and to enable the third party recipient to make the one or more cardless payments through the credit card terminal, wherein said one or more cardless payments requires input in to the credit card terminal of a specific mobile phone number that the credit card owner specified as part of the request to allocate said amount of money to said third party recipient;
receive, by the credit card terminal, the input of said mobile phone number that is required in order to process a specific cardless payment;
generate, by the one or more servers, in response to said input of said mobile phone number in to the credit card terminal, a one-time password (OTP) to be input in to the credit card terminal, and transmit said one-time password (OTP) to said mobile phone number;
receive, by the credit card terminal, the input of the one-time password (OTP);
verify, by the one or more servers or by the credit card terminal, that the one-time password (OTP) that was input in to said credit card terminal matches the generated one-time password (OTP); and
authorize, by the one or more servers or by the credit card terminal, the specific cardless payment upon said verification.

6. The system of claim 5, wherein said request to allocate said amount of money is reversible, and wherein the system further comprises: enable, by said one or more servers or said computer application, said credit card owner to cancel said allocation.

7. The system of claim 5, wherein said request to allocate said amount of money is irreversible, and wherein the system is further comprises: limit, by said one or more servers or said computer application, said credit card owner to cancel said allocation.

8. The system of claim 7 that further comprises: generate, by the one or more servers, in response to said irreversible request to allocate said amount of money, a message stating that said allocation of said amount of money is irreversible, and transmit the message to said mobile phone number.
